(19) United States
(12) Patent Application Publication
(10) Pub. No.: US 2007/0247843 A1
(43) Pub. Date: Oct. 25, 2007

(54) SURFACE SUPPORTED AREA LIGHTING MEDIA

(75) Inventors: Michael L. Schrimmer, Vernon Hills, IL (US); Ronald E. Gilley, Winnetka, IL (US)

Correspondence Address: LEVENFELD PEARLSTEIN;Intellectual Property Department, 2 North LaSalle, Suite 1300, CHICAGO, IL, 60602, US

(73) Assignee: CHEMICAL LIGHT, INC., Vernon Hills, IL (US)

(21) Appl. No.: 11/670,182

(22) Filed: Feb. 1, 2007

Related U.S. Application Data
(63) Continuation-in-part of application No. 11/379,341, filed on Apr. 19, 2006.

(51) Int. Cl. F21V 9/00

(52) U.S. Cl. 362/231

(57) ABSTRACT

A surface supported area lighting media assembly device comprises an illumination device to provide light of selected colors including white light by means of a chemiluminescent light emitting element or an LED light emitting assembly element and a reusable support element. The support element is configured for insertion into a support surface in a desired support orientation surface and includes a surface insertion spike and a stick receiving portion. The chemiluminescent element or LED element and the support element releasably engage one another to support the chemiluminescent element or LED element in the desired orientation when the support element is inserted into the support surface. The chemiluminescent element or LED element can be disengaged from the support element for replacing the chemiluminescent element or the LED element.

### CROSS-REFERENCE TO RELATED APPLICATION DATA

This application is a continuation-in-part (CIP) of application Ser. No. 11/379,341 filed on Apr. 19, 2006 entitled Surface Supported Lighting Media.

### BACKGROUND OF THE INVENTION

The present invention is directed to an area illuminating device. More specifically, the present invention is directed to an illuminating device that permits the lighting of an area or pathway wherein the illuminating device provides light of selected colors as determined by the materials of the illuminating device and the illuminating device is independently locatable upon a support surface by means of a surface supportable support element.

Outdoor illumination devices come in all manner, shape and size. Powered lighting is commercially available in alternating current (AC) and direct current (DC) types. Although powered lighting has the advantage of always being available, it requires that wire or cable be run from a power source to the light. This can be very expensive and, often, the lights cannot be readily moved once installed.

Other types of lighting are known, such as solar powered lamps. These lamps are limited in their use in that they can only be used after “charged” by the sun, or have a limited time to operate after being charged. Moreover, these lamps can be quite costly. This is particularly true when it is desired to illuminate a large area. Battery powered high intensity lamps are another alternative, however, the batteries for high intensity lighting would require frequent replacement (likely every day), which would also be costly very quickly.

Along these lines, golf has become a very popular game. In fact, it has become so popular, that tee times are extending later and later into the afternoon and as such, games are often called due to darkness. Illuminated golf balls, of the chemiluminescent type and electrical type (e.g., LED-containing) have come into use. While these balls allow a player to locate a ball and continue play, they do not provide any general area illumination or lighting for foot traffic along the course.

Although “hard-wired” lighting would be ideal along a golf course, the length of many courses (in excess of 7000 yards) and the width of such courses, makes such a lighting installing cost prohibitive. Moreover, the cost for solar powered lighting is also cost prohibitive due to the large number of lamps that would have to be installed and replaced on a likely fairly consistent basis.

Accordingly, there is a need for a conveniently available lighting device that can be placed as desired in any soft surface. Desirably, such a device is inexpensive and is readily replaceable. Most desirably, such a device can be actuated “as-needed”, in order to maximize usable life.

### BRIEF SUMMARY OF THE INVENTION

A conveniently locatable surface supported area lighting media assembly device is disclosed which comprises a replaceable light stick mounted upon a reusable support element. The support element is configured for insertion into a suitable penetrable surface such as a soft earthen ground area of grass bordering a path or any desired location to provide lighting guidance for a pathway. The support element includes a surface insertion spike and means for receiving an inserted light stick.

The light stick for the surface-supported area lighting media assembly device comprises a luminescent light stick to provide sufficient light for diffused illumination of a surface ground area. The light stick alternatively contains chromagens and an auxochrome color fixing group which, upon being inter-mixed, react to emit a chemical luminescence, or the light stick alternatively contains at least one semi-conductor light emitting diode (LED) to provide light emission when activated by a switch mechanism and contact with a suitable battery. The light emission of the light stick can be white or a selected color.

The chromagen of the chemiluminescent light stick operates as an enhanced fluorescent dye material of specific colors by presence of an auxochrome system. The LED of the LED light stick emits red, yellow and green and white emission light as a function of the LED materials. Color output LEDs, including white LEDs, are commercially available in a wide range of colors of emission light.

The surface supported area lighting media assembly device of the instant invention accordingly comprises a light stick containing chemical reagents to provide chemiluminescent light or a light stick containing an LED color light emitting assembly comprising at least one LED, a battery and an activating switch mechanism, to provide light emission, and a reusable support element. The support element is configured for insertion into a surface, for example, the earthen ground, in a desired location. The support element includes a surface insertion spike and a light stick receiving portion.

The invented surface supported lighting media assembly device provides an inexpensive, chemiluminescent or battery-powered lighting device that can be placed as desired in any independently located penetratable surface, such as along a golf course. The light stick is readily replaceable and advantageously, can be actuated “as-needed”, in order to maximize usable life.

The light stick and the support element releasably engage one another to support the light stick in a desired orientation when the support element is inserted into the support surface. The light stick can be disengaged from the support element for replacing the light stick.

In one form, as in FIGS. 1 and 2, the light stick includes an annular sleeve and the support element includes an insert portion configured for receipt in the sleeve. The support element can include an enlarged contact region, such as a flange at a location at which the light stick and the support element engage one another.

In one form as in FIGS. 3 and 4, the support element includes a sleeve receiving element configured for receiving the light stick. The support element can include a contact region (e.g., a base) within the sleeve receiving element to provide a location at which the light stick and the support element engage one another. Optionally, the support element includes a retaining element to releasably secure the light stick element in the sleeve element.

These and other features and advantages of the present invention will be apparent from the following detailed description, in conjunction with the appended claims.

### BRIEF DESCRIPTION OF THE DRAWINGS

The benefits and advantages of the present invention will become readily apparent to those of ordinary skill in the relevant art after reviewing the following detailed description and accompanying drawings, wherein.

FIG. 1 is a perspective view of a first exemplification of a surface supported area lighting media assembly device embodying the principles of the present invention by means of a light stick tube containing chromagens and an auxochrome which react to emit a chemical luminescent light upon being mixed.

FIG. 2 is an exploded view of the lighting media assembly device of FIG. 1;

FIG. 3 is an exploded view of an alternate exemplification of the support portion of FIG. 1;

FIG. 4 is a top view of the exemplification of FIG. 3 showing a split diaphragm arrangement for accommodating different sized light elements; and

FIG. 5 is a perspective view of an second exemplification of a surface supported lighting medium embodying the principles of the present invention by means of a light stick tube containing at least one semi-conductor light emitting diode (LED) which provides emission light activation by contact with battery and switch mechanism contained therein.

### DETAILED DESCRIPTION OF THE INVENTION

While the present invention is susceptible of embodiment in various forms, the invention is shown in the drawings and will hereinafter be described as a present exemplification with the understanding that the present disclosure is to be considered an exemplification of the invention and is not intended to limit the invention to the specific exemplification illustrated.

It should be further understood that the title of this section of this specification, namely, “Detailed Description Of The Invention”, relates to a requirement of the United States Patent Office, and does not imply, nor should be inferred to limit the subject matter disclosed herein.

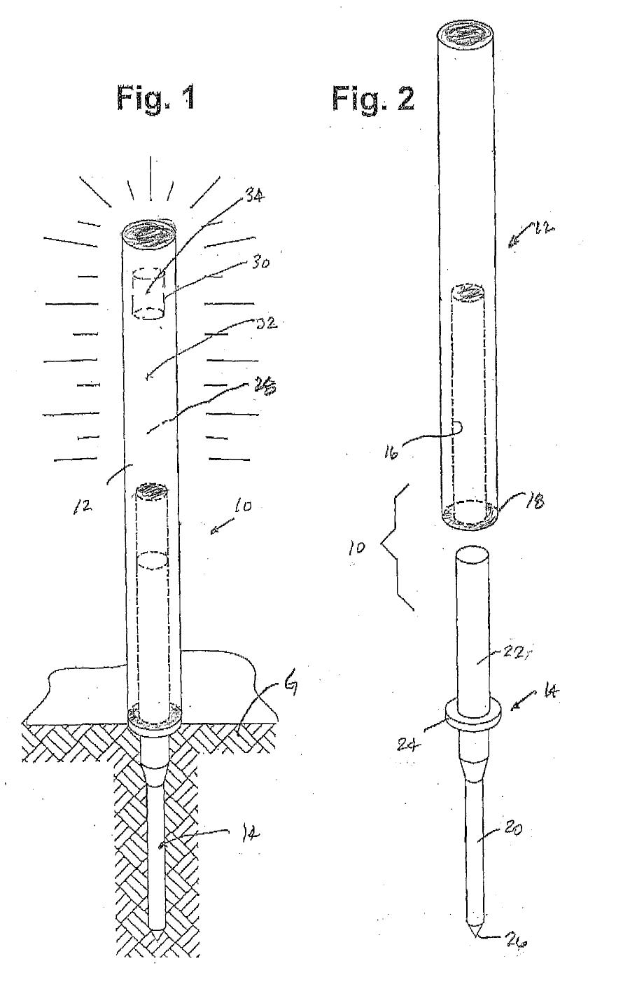

Referring now to the figures, and in particular to FIG. 1 and FIG. 2, there is shown an exemplification of a surface supported lighting media assembly device 10 embodying the principles of the present invention. The lighting media assembly device 10 includes illuminating light stick element 12, such as the illustrated chemiluminescent element (e.g., a first light stick) and a support element 14. The example of the media assembly device 10 in FIG. 1 includes light stick 12 having an annular top-sealed sleeve 16 formed in a bottom-sealed end 18 of light stick 12 that defines a socket or female portion of light stick 12. It is anticipated that the surface supported lighting media assembly device 10 will be used to, for example, illuminate the ground (e.g., a fairway or pathway, or indicate the location of a water hazard or sand trap) of a golf course, as a ground supported media. It will however be appreciated that the lighting media assembly device 10 can also be positioned in other surfaces, vertical as well as horizontal, to provide a cost effective, easily replaceable local lighting. The light stick 12 is supported in a desired orientation (e.g., vertical when in the ground and horizontal when in a wall or other vertical surface).

Referring to FIG. 2, the support element 14 includes a spike portion 20 and an insert 22 that is received in socket portion 16 of light stick 12. A flange 24 is disposed at the juncture of the insert 22 and the spike 20. The spike 20 is preferably formed with a penetrating tip 26.

Referring to the exemplification of FIG. 1 and FIG. 2, FIG. 1 illustrates the exemplification of a first light stick containing chemiluminescent light emitting elements. The chemiluminescent first light stick 12 can be any of a number of commercially available light sticks which provide chemical luminescence of colors as determined by the auxochrome. One preferred configuration of the first light stick 12 has a sealed outside chamber 28 and a breakable sealed inside chamber 30 within the sealed outside chamber 28. The sealed outside chamber 28 contains a first chemical solution 32 and the sealed internal chamber 30 contains a second solution 34 such that the sealed internal chamber 30 is breakable by a user so that the solutions 32, 34 mix and react with one another to chemically drive the chemiluminescent light emission. In one known combination of solutions the first solution 32 contains a reductant compound and a fluorescent dye compound and the second solution 34 contains an oxidant compound and a solvent. One known oxidant is hydrogen peroxide, which can be used as an oxalic phthalate reductant, and water solvent. Exemplary fluorescent dye compounds are 9,10-diphenylanthracene, 9,10-bis(phenylethynyl) anthracene, and 5,6,11,12-tetraphenylnaphthacene. Other combinations of chemicals and methods/materials for providing the chemiluminescent effect will be recognized by those skilled in the art and are within the scope and spirit of the present invention.

In use, the support element insert 22 is inserted into the sealed socket 16 of the sealed light stick 12, the sealed inside or internal chamber 30 in the light stick 12 is broken and the chemicals 32, 34 in light stick 12 are mixed to provide the chemiluminescent effect. The spike 20 of media 10 is inserted into a surface, for example into ground G, and the light stick 12 is supported in a desired orientation. Advantageously, the flange 24 provides a relatively large surface at which the light stick 12 and support 14 contact one another and by which pressure is exerted on the light stick 12. This prevents over-stressing the light stick 12 at the socket 16, which could otherwise result in tearing the light stick 12 material.

It will be appreciated that the exemplification of assembly device 10 of FIGS. 1 and 2 requires the use of a light stick 12 having a socket or female portion 16 in order to engage the upright ground support 14.

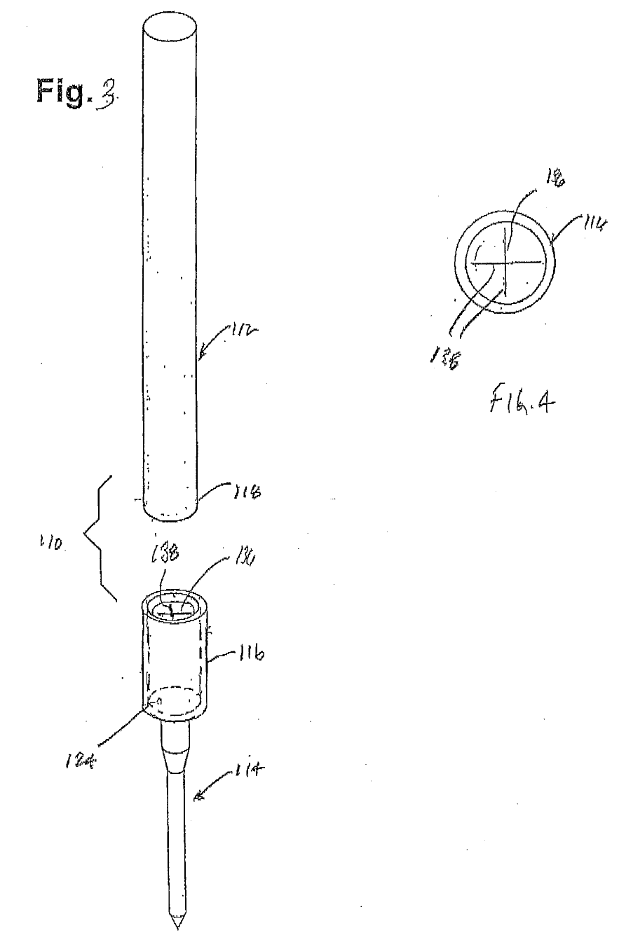

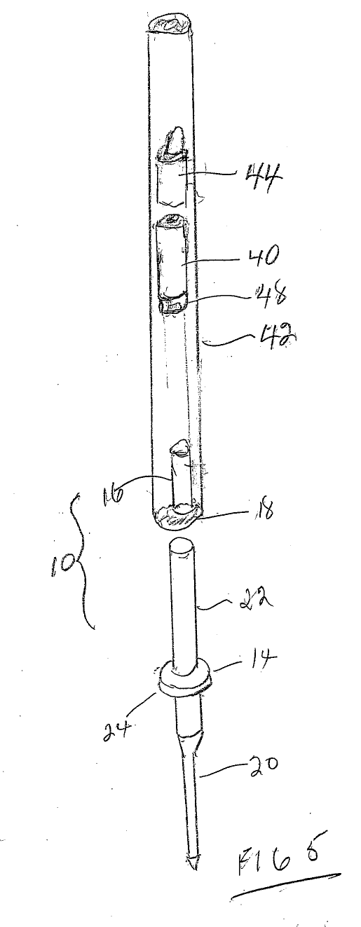

Accordingly, an alternate exemplification of the ground supported lighting media assembly device 110 is illustrated in FIGS. 3 and 4. In the alternate exemplification 110, the support element 114 includes a sleeve 116 into which the sealed light stick 112 is inserted or fitted. In this manner, a conventional, non-socket-containing sealed light stick 112 can be used to provide the ground supported lighting media 110. The sleeve 116 extends upwardly only so far as to provide support for the light stick 112, without blocking or interfering with too large of a portion of the lower end 118 of the stick 112. The base 124 of the sleeve or cup 116 provides a sufficiently large area over which pressure is exerted when inserting the media 110 into the ground G, again, to prevent overstressing the light stick 112. In the alternate exemplification 110, the chemiluminescent light emitting elements are present as illustrated in FIGS. 1 and 2 and, on mixing, provide the chemiluminescent effect.

Referring to FIG. 4, optionally, the support 114 can include a gripping element 136 inside of the sleeve 116 that can permit the support portion 114 and sleeve 116 to accommodate light sticks 112 of various diameters. The gripping element 136 can, for example, be formed by a thin, flexible inwardly extending membrane that is slit or cut radially (as at 138), or discrete, elongated “fingers” (not shown) that extend inwardly to engage the sides of the light stick 112 when the stick 112 is inserted into the sleeve 116.

Referring to the exemplification of FIG. 5, FIG. 5 illustrates the alternative exemplification of the light stick comprising a second light stick containing the LED light emitting assembly elements. The LED light assembly 42 comprises LED 44, battery 40, and switch mechanism 48. The LED light stick assembly 42 can comprise any of a number of commercially available LEDs and suitable batteries 40 activated by a switch mechanism 48. The LED, light emitting diode 44, when activated, provides an emission of light at a wave-length in the visible white, red, green and yellow light regions as determined by its composition material and dopants.

In use, the support element 22 is inserted into the socket 16 of the LED light stick 42, the inserted insert 22 activates the switch mechanism 48 and causes the LED 44 to emit a white or colored luminescence and/or light depending upon the composition characteristics of the LED. Upon removal of the LED light stick 42 from insert 22, the switch mechanism 48 is deactivated and the LED is turned off.

It will also be appreciated that the light stick can include UV other light emitting element(s) that may not be visible to the unaided eye.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concept of the present invention. It is to be understood that no limitation with respect to the specific exemplifications illustrated is intended or should be inferred. The disclosure is intended to cover all such modifications as fall within the scope of the disclosed, exemplary exemplifications.

What is claimed is:

1. A surface supported area lighting media assembly device comprising, in combination:
an illumination assembly device as a means of providing white light or light of selected colors emitted from an independent-locatable light source wherein the illumination assembly device comprises a light stick, and a reusable independent-locatable support element for the light stick, the support element configured for insertion into a support orientation in an independent-locatable support surface, the support element including a surface-insertion spike and a light stick receiving portion, wherein the light stick and the support element engage one another to support the light stick in a desired location orientation surface wherein the support element is inserted into the location orientation surface and wherein the light stick is disengageable from the support element for replacement of the light stick.

2. The surface supported area lighting media assembly device of claim 1 comprising an illumination device comprising, in combination, the light stick for providing white light or light of selected colors to light a surface area or pathway, the light as determined by materials of the light stick wherein the assembly device comprises
a first light stick containing chemiluminescent light emitting elements, or a second light stick containing an LED light emitting assembly element, and
the reusable area support element, wherein the area support element is configured for insertion into an orientation support area surface in a desired surface location, the area support element including an area surface insertion spike and a light stick receiving portion, wherein the first light stick or the second light stick are separately releasably engaged with the reusable area support element to support the first or second light stick in a desired location when the support element is inserted into the area surface, wherein the first or second light stick can be disengaged from the support element for replacing the first or second light stick.

3. The surface supported lighting area media assembly device of claim 2 wherein the first light stick and second light stick comprise an annular sleeve and the support element comprises an insert portion configured for receipt in the sleeve.

4. The surface supported area lighting media assembly device in accordance with claim 1 wherein the support element includes an enlarged contact region at a location at which the light stick element and the support element engage one another.

5. The surface supported area lighting media assembly device in accordance with claim 4 wherein the contact region comprises a support flange as an enlarged contact area.

6. The surface supported area lighting media assembly device in accordance with claim 1 wherein the support element includes a sleeve receiving element configured for receiving the first or second light stick.

7. The surface supported lighting area media assembly device in accordance with claim 6 wherein the support element includes a contact region within the sleeve receiving element wherein the first light stick or second light stick and the support element engage one another.

8. The surface supported area lighting media assembly device in accordance with claim 6 wherein the support element includes a retaining element to releasably secure the first light stick or second light stick in the sleeve element.

9. The surface supported area lighting media assembly device of claim 1 wherein light emitted from the independent-located light source is a white light.

10. The surface supported area lighting media assembly device of claim 1 wherein light emitted from the independent-locatable light source is a colored light and the colored light is red, green, blue or yellow.
